(19) United States
(12) Patent Application Publication
(10) Pub. No.: US 2008/0188255 A1
(43) Pub. Date: Aug. 7, 2008

(54) METHOD AND SYSTEM FOR THE DISTRIBUTION OF DATA TO THE FIXED IP NETWORK ENVIRONMENT BY MEANS OF A MEDIA DISTRIBUTION FUNCTION

(75) Inventor: Stephan BLICKER, Wachtberg-Villip (DE)

Correspondence Address: THE MAXHAM FIRM, 9330 SCRANTON ROAD, SUITE 350, SAN DIEGO, CA, 92121, US

(73) Assignee: T-MOBILE INTERNATIONAL AG & CO. KG, Bonn (DE)

(21) Appl. No.: 12/025,533

(22) Filed: Feb. 4, 2008

Related U.S. Application Data
(63) Continuation of application No. PCT/EP2006/007672, filed on Aug. 3, 2006.

(30) Foreign Application Priority Data
Aug. 4, 2005 (DE) 102005037318.6
Dec. 1, 2005 (DE) 102005057649.4

(51) Int. Cl. H04B 7/00

(52) U.S. Cl. 455/518

(57) ABSTRACT

A method and a system for distributing data (media distribution function, MDF). Interfaces to the fixed IP network environment are provided, user data and signal data being transmitted via a network element which is designated specifically for this purpose.

### FIELD OF THE INVENTION

The invention relates to a procedure and a system for distributing information in a communications network.

### DISCUSSION OF PRIOR ART

In general, in communications networks exchanging information of various media between networks and technologies has not been satisfactorily available. Generally relevant information is identified below.

The article, “Push to Talk: A First Step to a Unified Instant Communication Future,” in: Engineering Wireless Multimedia: Services and Technologies, 2005, XP-002367504. ISBN: 0-470-02149-7, gives an overview of the so-called push-to-talk procedures, which provides interfaces to the fixed IP network realm and across which, via user and signal data are transmitted via a certain element, a so-called Push-Talk Server, a network component specifically designed for such purposes.

The patent publication, US 2004/0224710 A1, relates to a system and procedure for the preparation of servers in a push-to-talk environment, whereby a push-to-talk server is envisaged that enables a data exchange between a PTT client and a PTT application server.

### SUMMARY OF THE INVENTION

A purpose of this invention to provide a system for distributing information in a communications network.

Embodiments of the invention are based on a new type of Media Distribution Function (MDF), where the PoC Server (Push-to-Talk over Cellular) is used as an enabling system for the transmission of data.
The Media Distribution Function (MDF) is a new network component whose interface is available for the fixed IP network realm of all well-known applications.
The MDF can be implemented as part of the future Open Mobile Alliance (OMA) PoC architecture. The OMA is a combination of leading service and product providers in the area of cellular phone network with the goal of marketable, interoperable digital services and to establish them worldwide.

### MDF High Level Use Cases

Authentication of the subscriber with respect to the access network
Conversion of group Emails into PoC speech to groups
Conversion of instant speech into PoC speech
Click-on speech (video, only audio) on an Internet application
Enables transmission from games/applications/documents via PoC on mobile devices from the Internet application
Serves as an interface to conference systems
Conversion of audio news, news in brief, TV news to PoC
Provides PoC Presence to Internet applications
Provides PoC group list information to Internet applications

### MDF Requirements

Requires an interface to OMA Group Administration XDMS (XML Document Management Server)
Requires an interface to the OMA Presence Server
Requires an interface to the OMA PoC System
Requires an authentication mechanism (perhaps based on SIM, or on RADIUS)
Requires protocol support of the Internet type (smtp, rtp, sip, http)

### BRIEF DESCRIPTION OF THE DRAWING

The objects, advantages and features of the invention are explained in further detail by the following detailed description, when read in conjunction with the drawing, wherein:

FIG. 1 is a system block diagram overview of the MDF architecture in accordance with the invention;

FIG. 2 is a detailed overview of the MDF architecture of FIG. 1;

FIG. 3 is a flow chart showing the signaling procedure during the authentication of a client application with respect to the IMS network, in accordance with the invention;

FIG. 4 is a flow chart showing the signaling procedure during the authentication of a user with respect to a client application, in accordance with the invention;

FIG. 5 is a flow chart of the procedure during a transmission from RTP media via the PoC Server to a terminal, in accordance with the invention;

FIG. 6 is a flow chart showing XDMS operations for retrieving lists and data from the PoC XDMS server, in accordance with the invention;

FIG. 7 is a flow chart showing XDMS operations for placing lists and data on the PoC XDMS Server, in accordance with the invention;

FIG. 8 is a flow chart showing possible presence operations (retrieving) in connection with the PoC Presence Server of FIG. 1;

FIG. 9 is a flow chart showing possible presence operations (placing) in connection with the PoC Presence Server of FIG. 1; and

FIG. 10 is a flow chart showing an example of the procedure in accordance with the invention during mail operations.

### DETAILED DESCRIPTION OF THE PREFERRED EMBODIMENTS

### Architecture of the Media Distribution Function (MDF)

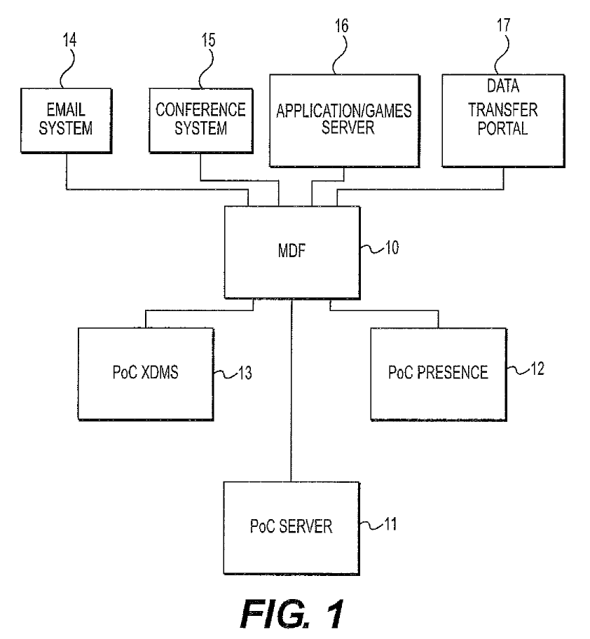

In FIG. 1, the architecture of the communications network in connection with media distribution function (MDF) 10 is schematically illustrated. The MDF is connected via suitable interfaces with PoC Server 11, PoC Presence Server 12 and PoC XMDS Server 13. On the other side, the MDF is connected with Email System 14, conference system 15, Applications/Games Server 16, as well as to data transmission or transfer portal 17. MDF 10 is able to transmit media between all of these applications and application servers.

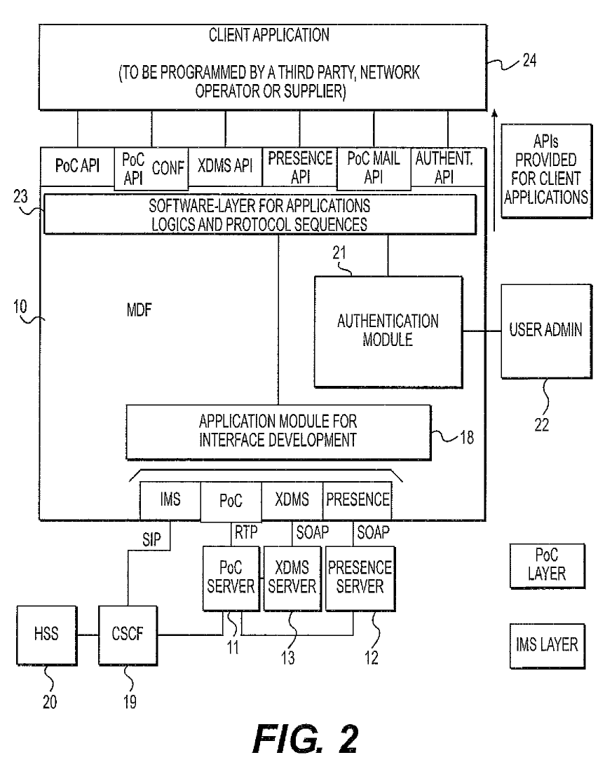

Open Mobile Alliance (OMA) tasks (prospective) with the integration of the MDF 10.
Standardization of MDF features
Standardization of interfaces, ITF, between MDF 10 and XDMS PoC Server 13 and PoC presence server 12
Specification of MDF tasks (as shown above)
FIG. 2 shows one of the architectures of the MDF 10 in detail. The MDF comprises application module for interface development 18, which is connected, for example, via an RTP interface with PoC Server 1. PoC Server 11 is connected with Call State Control Function (CSCF) 19 and to Home Subscriber Server (HSS) 20, both components of which are part of an IMS (IP Multimedia Subsystems). Application module 18 of the MDF is connected via a Session Initiation Protocol (SIP) interface with CSCF 18.

Presence Server 12 and XDMS Server 13 are both connected via Simple Object Access Protocol (SOAP) with the corresponding features of application module 18 of the MDF.

Furthermore, MDF 10 comprises authentication module 21 for authenticating users or administrators 22.

In addition, the MDF comprises software layer for applications logic and protocol sequences 23, which is connected via various Application Programming Interfaces (API), such as PoC API, XDMS API, among others, with various client applications 24.

Based on this architecture, the following scenarios can be considered, both as a Basic Server as well as an Advanced Server.

### Basic Server

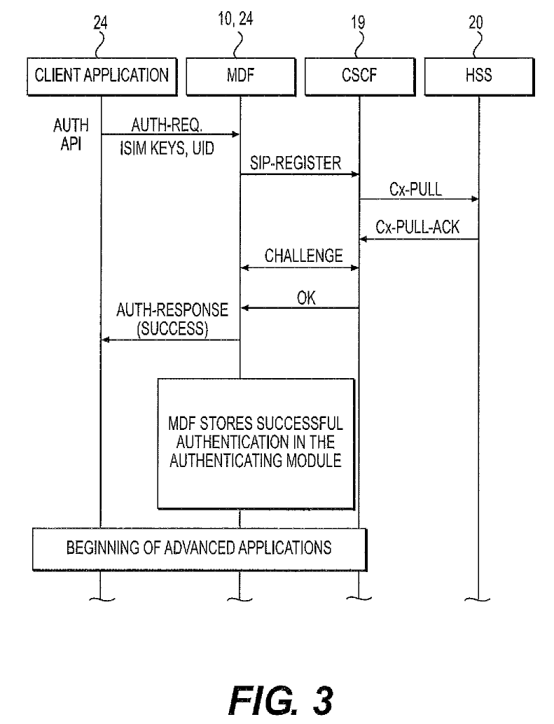

FIG. 3 shows the signaling procedure during authentication of a client application with respect to the IMS network. The authentication with respect to the IMS network takes place by means of an IP Multimedia Services Identity Module (ISIM), provided that ISIM is used in the client application. MDF 10 stores a successful authentication in authentication module 21. Subsequently, an advanced application can be started.

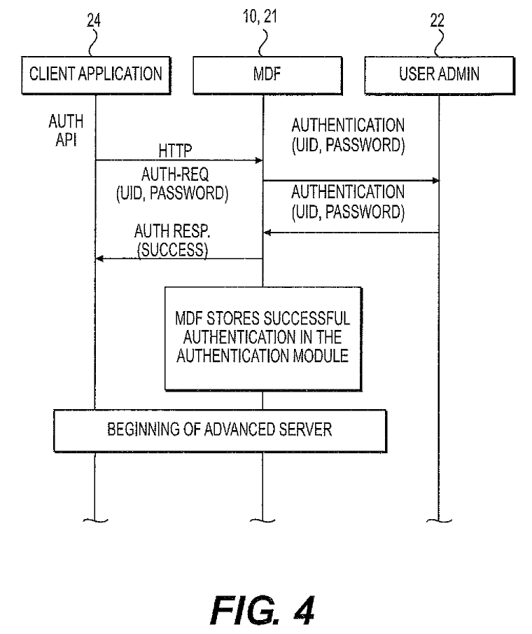

FIG. 4 shows the signaling procedure during an authentication of a user with respect to a client application. The authentication takes place, for example, with a user name (User Identification: UID) and password. The MDF stores a successful authentication in authentication module 21. Subsequently, an advanced application can be started.

### Advanced Server

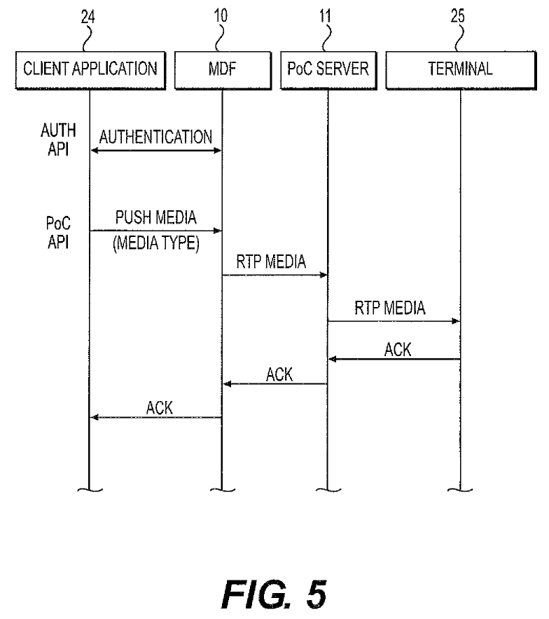

FIG. 5 shows the procedure during a transmission from RTP media via the PoC Server to end terminal 25. The following servers are conceivable:
“Push” transmission of a PoC News via PoC API (Application Programming Interface) for example, Speech Bursts, Blabla Maker, Instant Speech, Games, Applications, Documents, among others)
Retrieving/Placing of Group Lists
Retrieving/Placing of Contact Lists
Retrieving/Placing of Access-Control Lists
Retrieving/Placing of Presence Information

For the required PoC operations, the PoC API must provide the following characteristics:
Identification of the media to be transmitted (speech test, documents, instant news, games, ringtones, among others)
Transmission of the media to PoC Server 11 (when using the new RTP interface)
The Media Distribution Function must provide RTP packages to with the appropriate net load types.

The same procedure can also be applied in connection with the PoC conference-API.

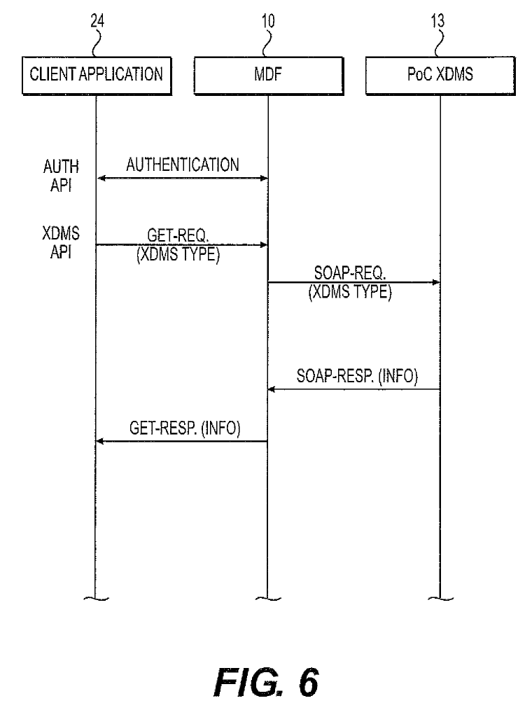

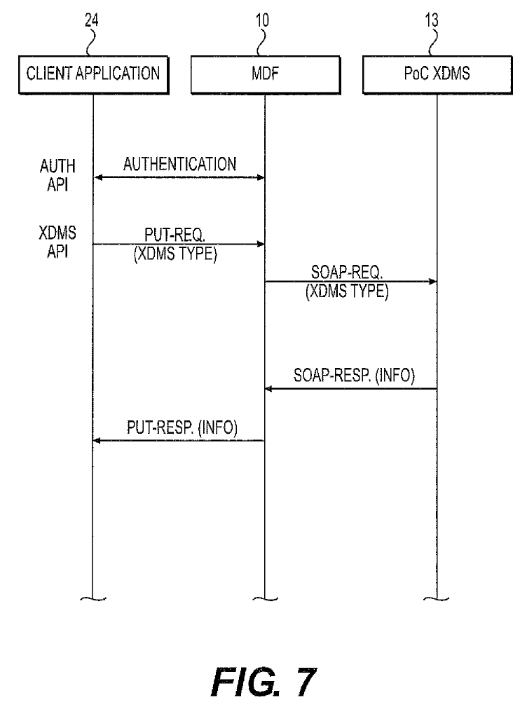

FIGS. 6 and 7 show XDMS operations for retrieving and placing lists and data from and to XDMS PoC Server 13:

According to the characteristics of the XDMS API, the following XDMS types are supported:
Retrieves Access-Control Lists
Places Access-Control Lists
Retrieves Group List Data
Places Group List Data
Retrieves Contact Lists
Places Contact Lists

This XDMS API is part of a comprehensive, general application. API provides access via SOAP interfaces.

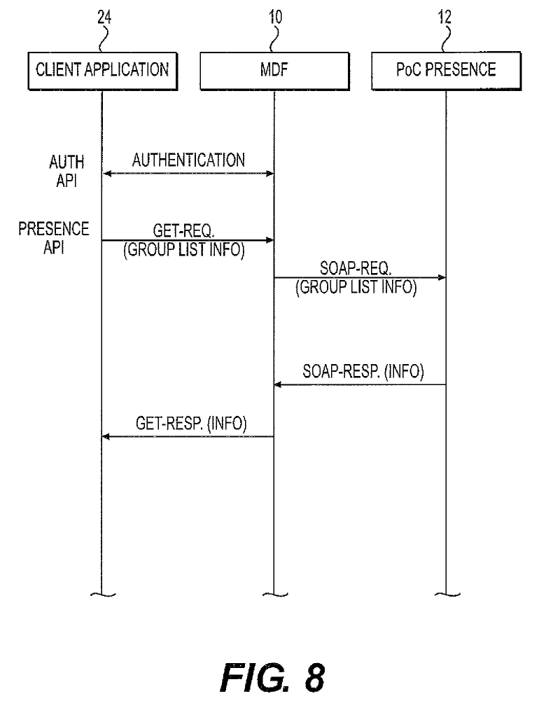

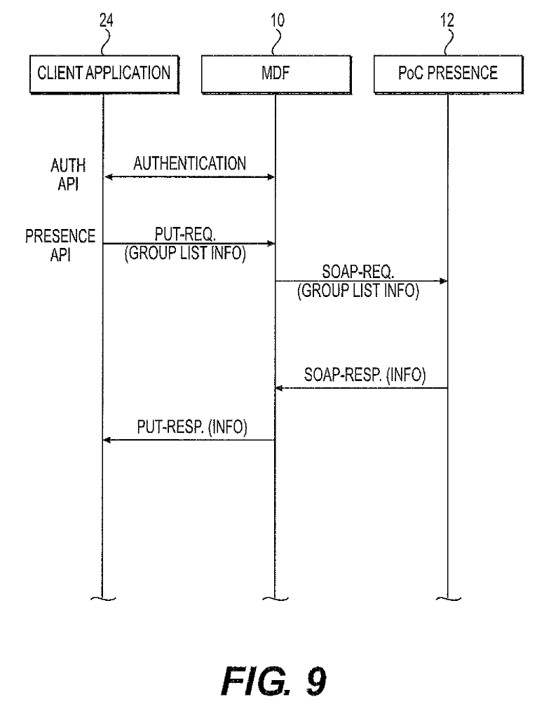

FIGS. 8 and 9 show possible Presence operations of client application 24 in connection with PoC Presence Server 12.

According to the characteristics of the Presence API, the following Presence Types are supported:
Retrieve Presence from Presence Server (FIG. 8)
Place Presence on the Presence Server (FIG. 9)

In addition, Group List Info must be provided.

This AP is part of a comprehensive, general application. API provides access via SOAP interfaces.

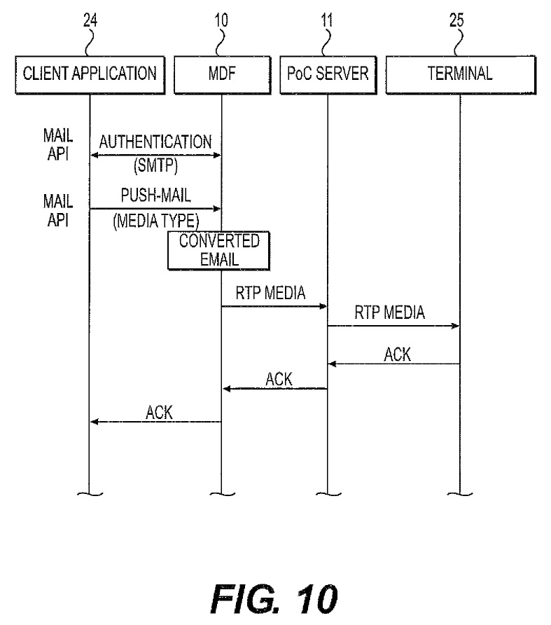

FIG. 10 shows an example of the procedure during mail operations. For example, according to the characteristics of the Mail API, the following Email types and procedures are supported:
Converted texts
Converted Wavs (Audio-data type: wav)
Provides SMTP access

Generally, the MDF provides a toolbox of functional API's. The client application can use the toolbox and can build its own application from it.

What is claimed is:

1. A method for the preparation of interfaces to a fixed IP network realm, whereby user and signal data are transmitted via a specially designed network component, the method comprising:
designing said network component with media distribution function (MDF);
connecting said MDF via suitable interfaces with a push-to-talk over cellular (PoC) server, a PoC presence server, and a PoC XML document management server Server (XDMS), as well as with an email system, a conference system, an application/games server and a data transmission portal; and
said MDF selectively transmitting between all of the said applications and application servers.

2. The method according to claim 1, wherein said network component selectively authenticates a client application with respect to an IP multimedia subsystem (IMS) network and authenticates a user with respect to a client application.

3. The method according to claim 1, wherein said network component comprises means for transmitting from RTP media via a PoC server to a terminal.

4. The method according to claim 2, wherein said network component comprises means for transmitting from RTP media via a PoC server to a terminal.

5. The method according to claim 1, wherein said network component comprises means to conduct XDMS operations for retrieving and placing lists and data from and to said XMDS PoC server.

6. The method according to claim 2, wherein said network component comprises means to conduct XDMS operations for retrieving and placing lists and data from and to said XMDS PoC server.

7. The method according to claim 1, wherein said network component comprises means to conduct presence operations of a client application in connection with said PoC presence server.

8. The method according to claim 2, wherein said network component comprises means to conduct presence operations of a client application in connection with said PoC presence server.

9. The method according to claim 1, wherein said network component comprises means to conduct mail operations.

10. The method according to claim 2, wherein said network component comprises means to conduct mail operations.

11. A system for the connection of at least two units of a mobile communications network for carrying out the procedure according to claim 1, wherein at least one of the system components in the form of a media distribution function (MDF), is configured to interconnect said applications and servers with each other.

12. A system for the connection of at least two units of a mobile communications network for carrying out the procedure according to claim 2, wherein at least one of the system components in the form of a media distribution function (MDF), is configured to interconnect said applications and servers with each other.

13. A system according to claim 11, wherein said at least one system component is selectively connected via suitable interfaces to said PoC server, to said PoC presence server and to said PoC XDMS server.

14. A system according to claim 12, wherein said at least one system component is selectively connected via suitable interfaces to said PoC server, to said PoC presence server and to said PoC XDMS server.

15. The system according to claim 11, wherein said at least one system component is selectively connected to said email system, said conference system, said application/games server, as well as to said data transmission portal.

16. The system according to claim 13, wherein said at least one system component is selectively connected to said email system, said conference system, said application/games server, as well as to said data transmission portal.
